(19) United States
(12) Patent Application Publication
(10) Pub. No.: US 2007/0231043 A1
(43) Pub. Date: Oct. 4, 2007

(54) Label-printing apparatus and label-printing program recorded on a computer readable recording medium

(75) Inventors: Tomoki Miyashita, Nagoya-shi (JP); Akihiko Niwa, Toki-shi (JP); Yoshitsugu Tomomatsu, Nagoya-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA

(21) Appl. No.: 11/729,081

(22) Filed: Mar. 28, 2007

(30) Foreign Application Priority Data
Mar. 29, 2006 (JP) 2006-090952

(51) Int. Cl. B41J 11/00

(52) U.S. Cl. 400/615.2

(57) ABSTRACT

An assumption is made a quantity of labels that make up a set of labels that is set in advance is A (S81). A determination is made as to whether or not a specified label exits between n th and (n+A−1)th in a history of printing stored in a history memory area 351 (S85). If a specified label does not exist between n th and (n+A−1)th, an object for processing is moved to a head label n+A of the following set (S87). If, however a specified label is found between n th and (n+A−1)th, a determination is made that the found label between n th and (n+A−1) th is of a set to which the specified label belongs (S89). Further, a set of labels determined in S89 is selected as an object for printing (S91). A determination can be made from the history of printing and from the quantity of labels that make up the set as to which set the specified label belongs, and the set of labels can be deemed as objects for printing.

### CROSS-REFERENCE TO RELATED APPLICATIONS

This application claims priority from JP 2006-090952, filed Mar. 29, 2006, the content of which is hereby incorporated by reference.

### BACKGROUND

1. Field of the Invention

The disclosure relates to a label-printing apparatus and a label-printing program.

2. Description of Related Art

Generally, printing of a plurality of papers or labels by means of a printing apparatus may be sometimes undertaken in sets. If printing in sets is restarted once it has been interrupted for some-reason, or reprinting is executed based on its history, a requirement may arise for not only printing a specified label but also for printing an entire set of labels. For example, an error may occur during execution of double-sided printing and afterwards, printing is restarted. In such circumstances a method has been proposed. In the method, when after printing of a front face has been completed in a normal manner, an interruption is caused by the occurrence of an error in the printing of the rear face, even when printing is recommended, care has to be taken to restart printing from the front face so as to avoid disturbing a relationship between the front and rear surfaces. See for example, Japanese Patent Application Laid-Open No. HEI 10-260806.

### SUMMARY

However, at times of reprinting also, a conventional printing apparatus of the type described above produces printing in sets constituted of two sides, a front face and a rear face. Accordingly, a printing apparatus of such a type cannot be applied in a case where, by means of specifying one among a set constituted by a plurality of labels, reprinting of all labels is desired.

The disclosure has been achieved to solve the above problem and an object is to provide a label-printing apparatus and a label-printing program that, even by the specification of one label, are capable of reprinting all labels of an entire set constituted by a plurality of labels.

To achieve the object described above, according to a first aspect, a label-printing apparatus is provided comprising: a printing device that prints a set of labels that constitute related sequential labels; a history memory device that stores a history of the printing of the labels; a printed data memory device that stores print data of printed labels whose history is stored in the history memory device; a counted number memory device that stores the quantity of labels that make up a set of the labels; a history of printing instructions input device that inputs a history of printing instructions for reprinting by specifying a label stored in the history memory device; a label-extracting device that extracts a set of labels to which belongs a specified label specified by the history of printing instructions input by the history of printing instructions input device by referring to a counted number stored in the counted number memory device and a history stored in the history memory device; and a set of labels printing control device that control so as to read the print data of the set of labels, the print data extracted by the label-extracting device from the print data memory device and to print the print data by the printing device.

According to a second aspect, a label-printing apparatus is provided comprising: a printing device that prints a set of labels that constitute related sequential labels; a history memory device that stored a history of the printing of the labels; a printed data memory device that stores print data of printed labels whose history is stored in the history memory device; a counted number memory device that stores the quantity of labels that make up a set of the labels; a history of printing instructions input device that inputs a history of printing instructions for reprinting by specifying a label stored in the history memory device; and a control device that controls so as to extract a set of labels to which belongs a specified label specified by the history of printing instructions input by the history of printing instructions input device by referring to a counted number stored in the counted number memory device and a history stored in the history memory device and to read the print data of the extracted set of labels from the printed data memory device and to print the print data by the printing device.

According to a third aspect, a label-printing program is provided that is recorded in a computer-readable recording medium, comprising: a history-storing step of storing a history of the printing of a set of labels that constitute related sequential labels; a printed data-storing step of storing print data of printed labels whose history is stored in the history memory step; a counted number-storing step of storing the quantity of labels that make up a set of the labels; a history of printing instructions input step of inputting a history of printing instructions for reprinting by specifying a label stored in the history-storing step; a label-extracting step of extracting a set of labels to which belongs a specified label specified by the history of printing instructions input in the history of printing instructions input step by referring to a counted number stored in the counted number-storing step and a history stored in the history-storing step; and a set of labels printing control step of controlling so as to read the print data of the set of labels which is extracted in the label-extracting step and to print the print data.

### BRIEF DESCRIPTION OF THE DRAWINGS

Exemplary embodiments will now be described in detail with reference to the accompanying drawings in which:

FIG. 1 is a schematic perspective view of a label printer according to the embodiment;

FIG. 2 is a perspective view showing a state in which a roll tape holder having a maximum roll tape width is loaded onto a label printer with its upper cover removed;

FIG. 3 is a side sectional view showing a state in which the roll tape holder is loaded onto the label printer with the upper cover removed;

FIG. 4 is a block diagram showing an electrical structure of the label printer;

FIG. 5 is a flowchart of a main routine of the label printer;

FIG. 6 is a flowchart of changes in setting processing to be executed during the main routine;

FIG. 7 is a flowchart of the history of printing processing to be executed during the main routine;

FIG. 8 is a flowchart of sets of labels selection processing to be executed during the history of printing processing;

FIG. 9 is a flowchart of ordinary printing processing to be executed during the main routine; and

FIG. 10 is an explanatory diagram showing an example of a label specifying screen.

### DETAILED DESCRIPTION OF EXEMPLARY EMBODIMENTS

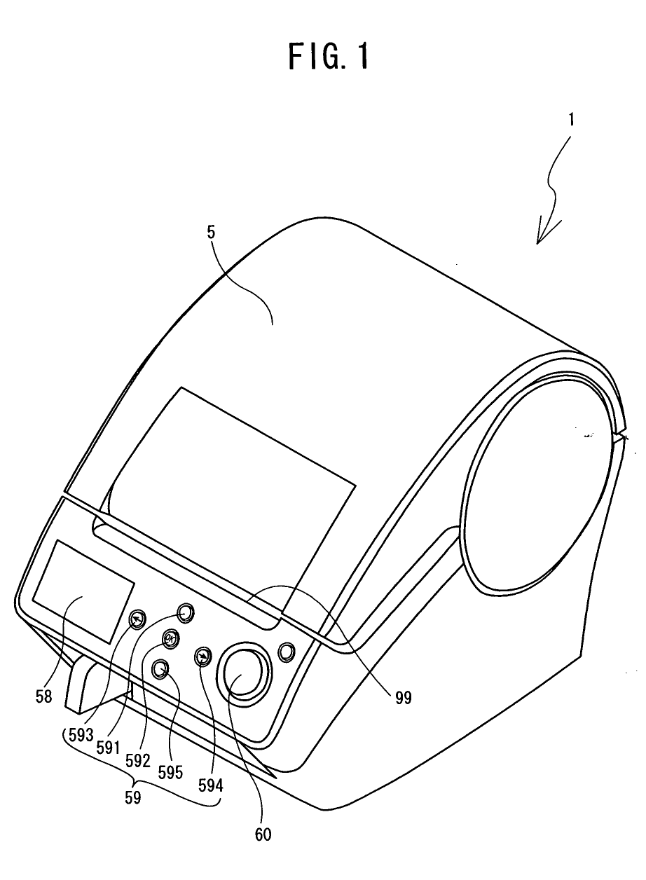

Hereinafter, the label printer 1 of the embodiment will be described with reference to the accompanying drawings. First, the structure of the label printer 1 will be explained with reference to FIGS. 1-4.

As shown in FIGS. 1-3, the label printer 1 includes a roll tape holder-accommodating portion 4 which accommodates a roll tape holder 3 in a rear portion of a main body casing 2 whose bottom face is formed in a substantially rectangular shape. The roll tape holder 3 is constituted by winding a label paper 81 having a predetermined width therearound. In the label paper 81, a plurality of labels are disposed on a mount on the tape evenly spaced apart and affixed to that mount. The label paper 81 is wound around the roll tape holder 3 with the surface to which the label is affixed (a front surface) facing inwards.

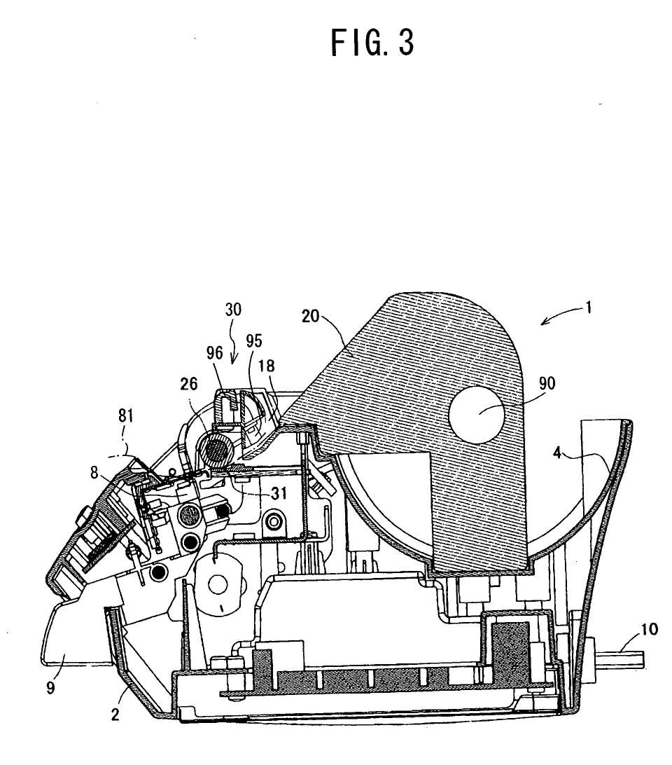

The label printer 1 further includes a printing mechanism 30 which stores a platen roller 26 and a thermal head 31 (see FIG. 3) on its front side. A transparent resin-made upper cover is provided at an upper edge portion of the rear side in such a way that it can be opened/closed freely so as to cover the top of the roll tape holder-accommodating portion 4. Then, a cut lever 9 which controls movement of a cutter unit 8 in a sideways direction (see FIG. 3) is provided on the front face of the main body casing 2. A power button 60, a variety of input keys 59 for use in inputting printing instruction and a liquid crystal display 58 are provided on the front side of the top face of the main body casing 2.

In this context, the input keys 59 comprise a print key 591 for inputting printing instructions, a menu key 592 which displays and establishes a menu for a variety of settings, a forward-feeding key 593 and a backward-feeding key 594 for feeding respectively forwards and backwards, and a cancel key 595. A power cord 10 is connected to the rear face of the main body casing 2 and further, a connector portion (not shown) is provided that is made up of an item such as an universal serial bus (USB) which is to be connected to an item such as a personal computer (not shown).

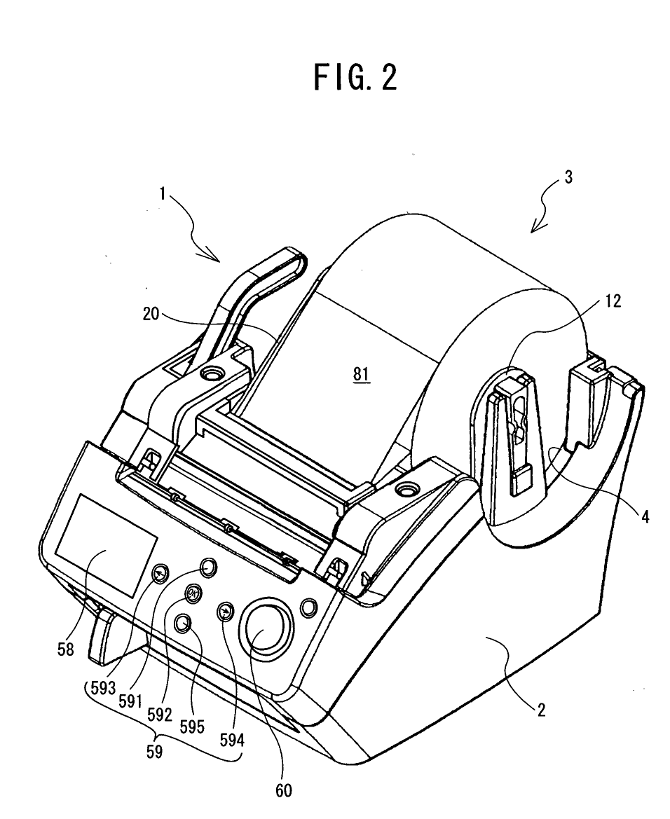

As shown in FIGS. 2, 3, the roll tape holder 3 is provided with a shaft member 90 (see FIG. 3) around which a label paper 81 is wound. A positioning holding member 12 made of thin sheet material is provided perpendicularly to the shaft member 90 at an end (right end in FIG. 2) of the shaft member 90. Further, a guide member 20 which is a thin sheet member is provided perpendicularly to the shaft member 90 at the other end (left end in FIG. 2) of the shaft member 90. The label paper 81 is wound around the shaft member 90 in such a way that the front surface of the mount faces inward. Moreover, the label paper 81 is nipped by the positioning holding member 12 and the guide member 20 so that its winding is never deflected.

As shown in FIG. 3, an end of the label paper 81 is inserted into the printing mechanism 30 from an insertion port 18 which is opened in a narrow shape in a right and left direction of the label printer 1 on the top of the printing mechanism 30. The label paper 81 inserted into the printing mechanism 30 from the insertion port 18 is scanned by an optical sensor 95 that is provided on a frame portion 96 so as to read a sensor mark printed on the rear face of the mount of the label paper 81. This sensor mark is used for identifying types of paper, such as the label paper 81, that is wound around the roll tape holder 3. More specifically, light from a light-emitting portion of the optical sensor 95 is irradiated onto the rear face of the label paper 81 and then its reflected light is received by a light-receiving portion of the optical sensor 95 that is made up of an item such as a photo transistor so as to detect the sensor mark.

The thermal head 31 and the platen roller 26 are provided downstream of the optical sensor 95 in a transportation direction of the label paper 81. This platen roller 26 is a substantially cylindrical roller provided in the right and left direction of the label printer 1. The thermal head 31 is a line-type thermal head which is provided in a right and left direction of the label printer 1 at a position opposite to the platen roller 26 so as to print in rows in a tape width direction (direction of a short side of the tape) of the label paper 81. Further, when printing takes place, the label paper 81 inserted into the insertion port 18 is pulled out from the roll tape holder 3 and transported by means of a rotation of the platen roller 26, and image data is printed successively on a print face by means of driving control on the part of the thermal head 31. Printed label paper 81 is further discharged from a discharge port 99 provided between the upper cover 5 and the main body casing 2, and cut out by the cutter unit 8.

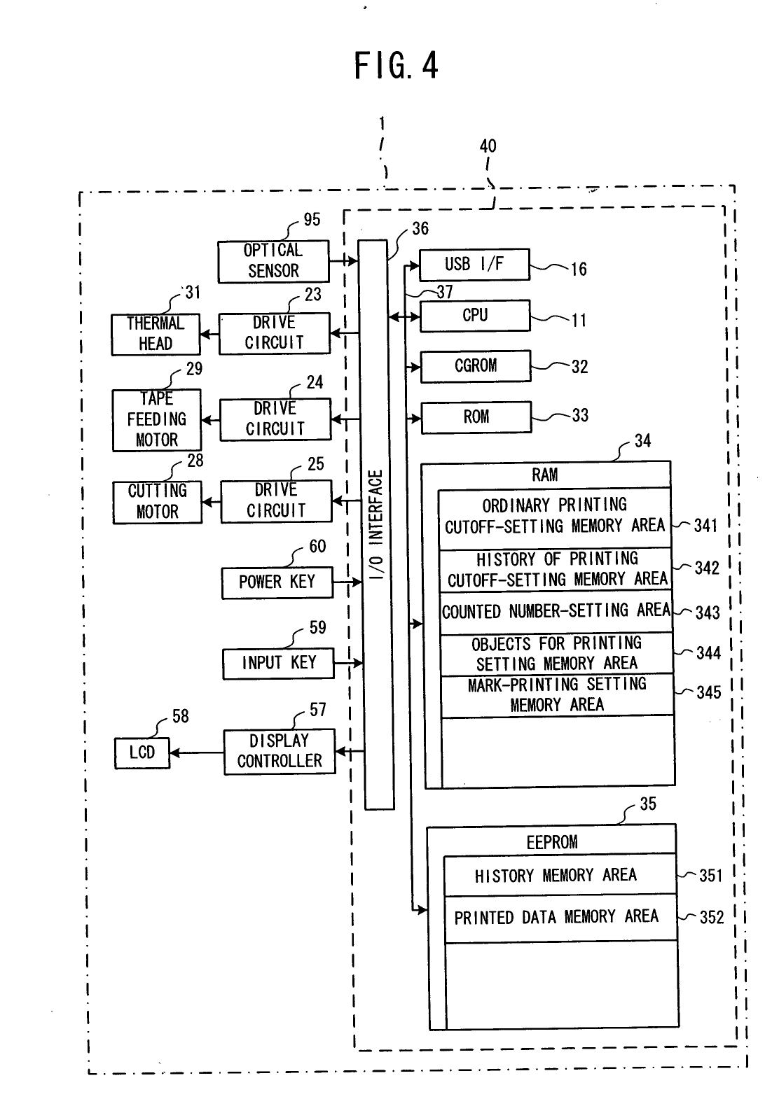

Next, the electronic structure of the label printer 1 will be described with reference to FIG. 4. The label printer 1 is provided with a main control board 40, and the main control board 40 includes a CPU 11 for conducting main control of the label printer 1. A CGROM 32, a ROM 33, a RAM 34, an USB interface 16, an EEPROM 35 and an I/O interface 36 are connected to the CPU 11 through a data bus 37. The CGROM 32 stores graphic data such as characters and symbols, and the ROM 33 stores the control program. The RAM 34 stores print data, other data, flags and like that received from a personal computer (not shown), and the EEPROM 35 stores the history of printing. Further, the USB interface 16 communicates with the personal computer.

In this context, the RAM 34 contains an ordinary printing cutoff-setting memory area 341, a history of printing cutoff-setting memory area 342, a counted number-setting memory area 343, printing object-setting memory area 344, mark printing setting memory area 345 and other memory areas (not shown). The ordinary printing cutoff-setting memory area 341 stores whether or not cutoff is to be executed for each label at a time of ordinary printing. The history of printing cutoff-setting memory area 342 stores whether or not cutoff is to be executed for each label at a time of making a history of printing. The counted number-setting area 343 stores the quantity of labels constituting a set. The printing object-setting memory area 344 stores whether only a specified label or an entire set belonging to the specified label is to be handled as a object for printing. The mark printing-setting memory area 345 stores whether or not printing a mark indicating reprinting is to be executed at the time of making a history of printing.

The EEPROM 35 includes a history memory area 351 for storing the history of printing and a printed data memory area 352 which stores data of printing that has been executed for the history of printing.

As shown in FIG. 4, an optical sensor 95, drive circuits 23, 24, 25, a power key 60, input keys 59 and a display controller 57 are connected to the I/O interface 36 of the label printer 1. The optical sensor 95 is accommodated in the roll tape holder-accommodating portion 4 in order to detect the type of tape. The drive circuit 23 drives the thermal head 31. The drive circuit 24 drives a tape feeding motor 29 for rotating the platen roller 26. The drive circuit 25 drives a cutting motor 28 for actuating the cutter unit 8 for purposes of cutting a tape. The power key 60 gives instructions for ON/OFF switching of the power. The plural input keys 59 are provided for inputting instructions for actions such as printing and reprinting. The display controller 57 controls a liquid crystal display 58.

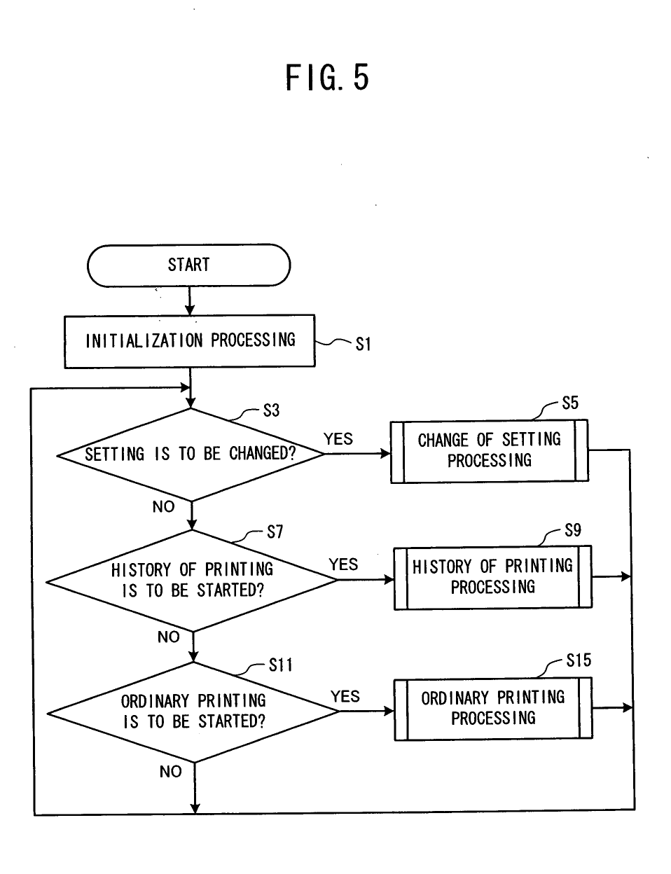

Next, operations of a label printer 1 with such a structure will be described with reference to FIGS. 5-10.

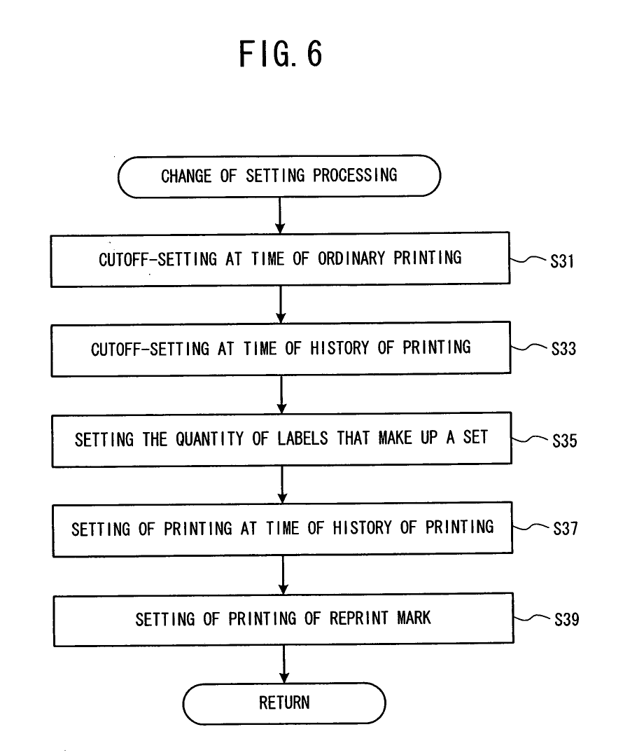

If the power of the label printer 1 is turned ON so that a main routine is started, a memory area of the RAM 37 is first deleted and initialization processing is executed for returning each setting value to a predetermined value (S1). Next, a determination is made as to whether or not instructions have been given for a change of setting (S3). If a change of setting has been carried out (S3: YES), change of setting processing for various settings is executed through a display on a setting screen (S5). Then, the processing returns to S3. Further, details of the change of setting processing will be described later with reference to FIG. 6.

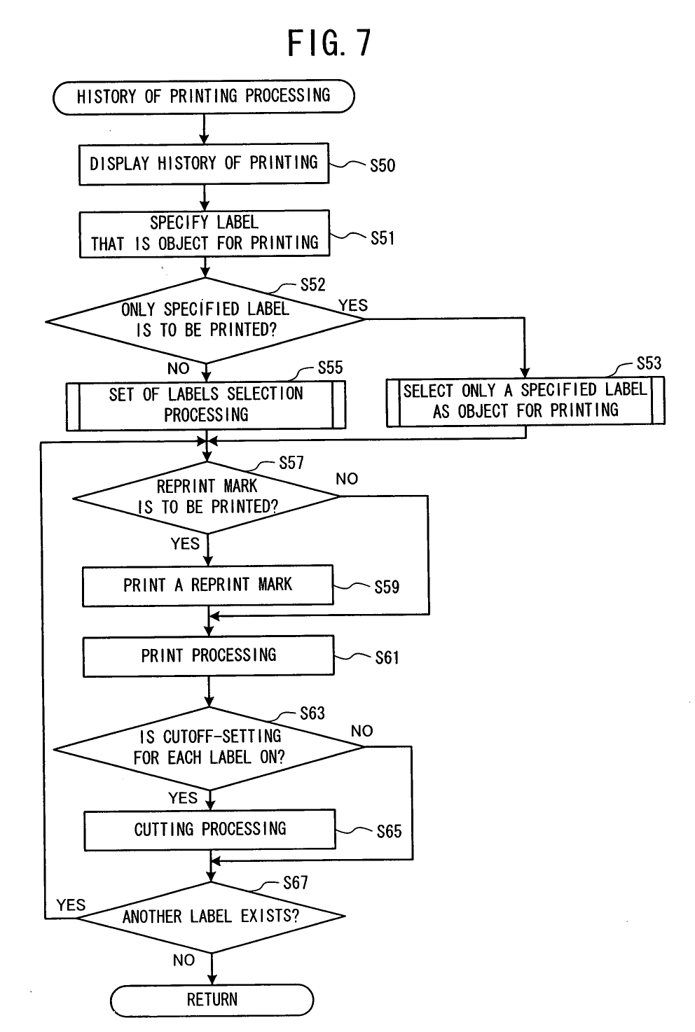

In circumstances where processing cannot be changed (S3: NO), a print key 591 is pressed and a determination is made as to whether or not instructions for the history of printing have been issued from a menu displayed on the liquid crystal display 58 (S7). In circumstances where the history of printing has been started (S7: YES), a specification of a label that it is desired to be printed is input by a user from the printed data whose history has been stored in the history memory area 351. Then a history of printing processing is executed for printing the specified label (S9). Then, the processing returns to S3. Further, details of the history of printing processing will now be described later with reference to FIGS. 7, 8, and 10.

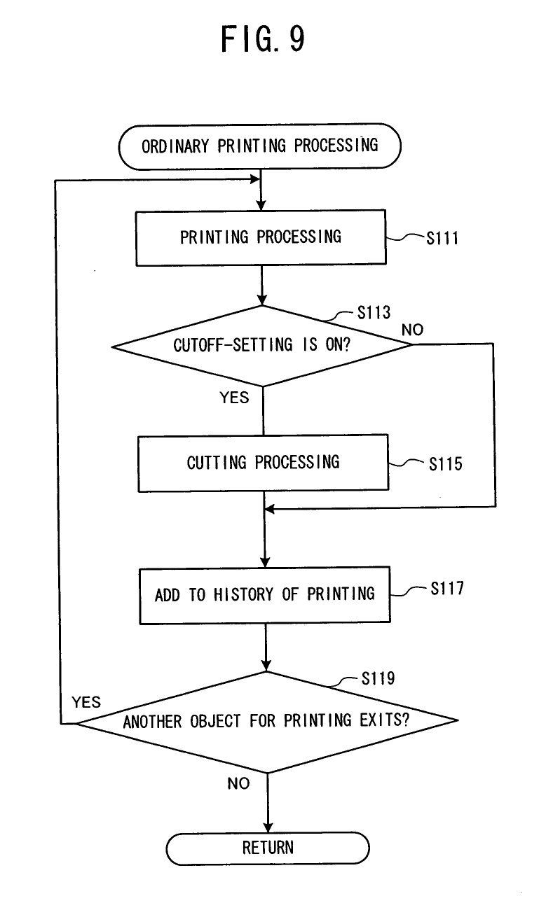

Unless the history of printing processing is about to start (S7: NO), the print key 591 is pressed and a determination is made as to whether or not instructions for start of ordinary printing have been executed from the menu (S11). If instructions for start of the ordinary printing have been executed (S11: YES), ordinary printing processing based on the new print data is executed (S15). Then, the processing returns to S3. Details of ordinary printing processing will also be described later with reference to FIG. 9. The label printer 1 executes processing of steps S3-S11 repeatedly while power is switched ON.

Next, the change of setting processing to be executed in the main routine will be described with reference to FIG. 6. If the menu key 592 is pressed so that a setting is selected from the menu displayed on the liquid crystal display 58, a variety of settings can be executed in succession. First if the ordinary printing processing is executed based on new print data, a setting is made as to whether or not cutoff is to be executed (cutoff-setting at times of ordinary printing ON/OFF) in units of individual labels (S31). For this purpose, an ON or OFF indication may be changed over by means of the forward feed key 593 or the backward feed key 594 so as to establish either one of them by means of the menu key 592. A setting content input in this way is stored in the ordinary printing cutoff-setting memory area 341.

Next in the case of the history of printing involving a label specified from print data of printing that has already taken place, a setting is made as to whether or not a cutoff should be executed for each label (history of printing cutoff-setting ON/OFF) (S33). As in the case of the ordinary printing setting, a setting menu is displayed on the liquid crystal display 58 and then, input may be carried out with the forward feed key 593, the backward key 594 or the menu key 592. A setting content that has been input in this way is stored in the history of printing cutoff-setting memory area 342 within the RAM 34. In this embodiment, a setting is made as to whether or not a cutoff is required in units of individual labels within a set because a cutoff is always executed in units of a set. However, it is also permissible to make a setting as to whether or not a cutoff should be executed in units of a set.

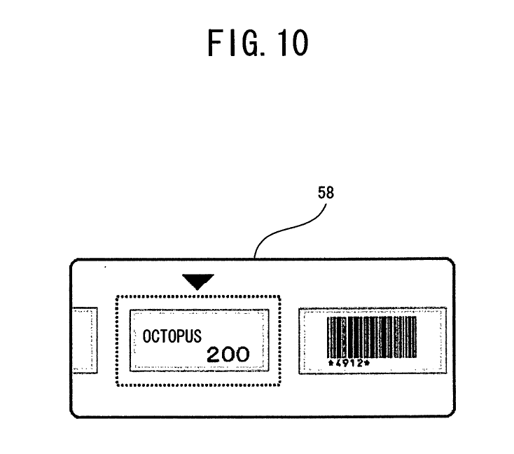

Next, a setting is made for the quantity of labels that should constitute a set (S35). In this embodiment, as assumption is made of a case in which printing is performed of a plurality of sets of labels made up of sets. For example, as shown in FIG. 10, in this configuration one set is made up of two labels in each of which a product name and a bar code are printed, and 30 such sets are printed. In these circumstances, by setting in advance the quantity of labels that are to form a set, a determination can be made as to which set a certain label belongs to from simple history information even when special data indicating to which set data belongs or special data indicating that two labels belong to the same set is not stored. For example, in the example that has just been quoted, “2” is the quantity of labels that make up a set. In this case also, the setting menu is displayed on the liquid crystal display 58 and input is performed with the forward feed key 593, the backward feed key 594 or the menu key 592. A setting content input in this way is stored in the counted number-setting area 343 within the RAM 34.

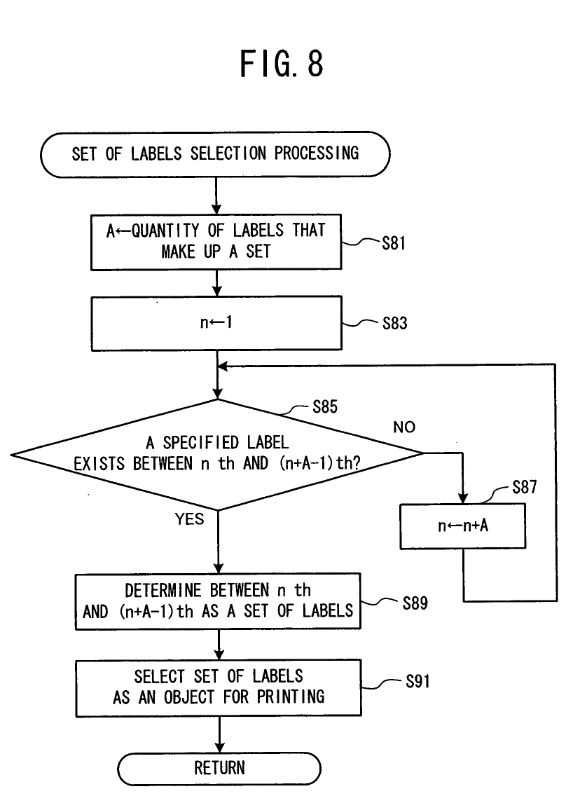

Next, in circumstances where instructions are given for the history of printing, a setting is made as to whether only a specified label is to be printed or whether an entire set to which the specified label belongs is to be printed (S37). In instructions for the history of printing, a preview of printed data whose history is stored is displayed on the liquid crystal display 58, as shown in FIG. 10, and a label that it is desired to be printed is specified by means of the forward feed key 593, the backward feed key 594 or the menu key 592. Because a set is made up of plural labels that have been set at the time of setting the counted number, all labels belonging to the set can automatically be regarded as an object for printing (see description of FIG. 8, which will be described later), or alternatively only a specified label can be printed. Either of such settings can be performed in the course of this step. Printing of the entirety of labels in a set, or printing of only a specified label, is stored in the printing object-setting memory area 344 within the RAM 34 according to the setting content.

Next, if instructions are given for the history of printing, a setting is made as to whether or not a mark is to be printed that indicates that the print is for the history of printing (reprint) (S39). If, for example, there is only space enough for the mark to be printed on the mount of the label paper 81, the reprint mark may be printed there, or, alternatively it is possible for only the reprint mark to be printed onto a label before an object label is printed, and for appropriate printing to be selected. A setting content here is stored in the mark printing setting memory area 345 within the RAM 34. The various settings are completed in the course of procedure described above and thus, the change of setting is completed and the processing returns to the main routine.

Next, the history of printing processing to be executed in the main routine will be described with reference to FIG. 7. If the history of printing processing is started, the history of printing is first displayed in a preview form on the liquid crystal display 58 (S50). Specification of a label that it is desired to be printed can be stipulated by means of the forward feed key 593, the backward feed key 594 or the menu key 592 (S51).

Next, the printing object-setting memory area 344 is referred to so that a determination is made between a setting of printing only a specified label and a setting of printing all labels in a set to which the specified label belongs (S52). If only a specified label needs to be printed (S52: YES), only a label specified in S51 is selected as an object for printing (S53).

If, on the other hand, a setting of printing all the labels to which the specified label belongs is selected (S52: NO), a set of labels selection processing is executed so as to select a set to which the specified label belongs (S55: YES). Details of the set of labels selection processing will be described later with reference to FIG. 8.

If an object for printing is selected in S53 and S55, the mark printing setting memory area 345 is next referred to so as to determine whether or not a reprint mark is to be printed (S57). If the reprint mark is not to be printed (S57: NO), the processing proceeds directly to S61. If the reprint mark is to be printed (S57: YES), the reprint mark is printed on the label or on the mount (S59) and then, processing of printing for a label that is an object for printing is executed (S61).

Next, the history of printing cutoff setting memory area 342 is referred to so as to make a determination as to whether or not cutoff setting is intended in units of individual labels (S63). If the cutoff-setting is OFF (S63: NO), the processing proceeds to S67 directly. If the cutoff-setting is ON (S63: YES), the label paper 81 is cut off by means of the cutter unit 8 (S65).

Next, a determination is made as to whether or not a subsequent label exists which is an object for printing is determined (S67). If such a subsequent label exists (S67: YES), the processing returns to S57, and the processing described above is repeated. If a subsequent label does not exist (S67: NO), the processing returns to the main routine.

Next, the sets of labels selection processing to be executed in the history of printing processing will be described with reference to FIG. 8. When the set of labels selection processing is started, first, the counted number-setting memory area 343 is referred to and the quantity of labels that should make up a set is set as composite counted number count A (S81). Next, 1 is set as a label n that is to be the object of processing (S83). A determination is made as to whether or not a specified label between n th and (n+A−1)th labels has been stored in the history memory area 351 (S85). For example, when the composite counted number A is 3 and n is 1, (n+A−1) is 3. Thus, a determination is made as to whether or not a specified label falls within the history of between the first and the third labels.

If no specified label exists between n th and (n+A−1)th, n+A is set to n because the object of printing is being transferred to a head label of the following set (S87). For example, because in the above example, A is 3 and n is 1, the following n is 4. Therefore, a determination is made as to whether or not any specified label exists in a set made up of a history of between the fourth and the sixth labels in following S85.

If any specified label is found among those between n th and (n+A−1)th, a determination is made that a label found between n th and (n+A−1) th is of a set to which the specified label belongs (S89). Further, the labels of a set determined in S89 are selected as objects for printing (S91). Then, the processing returns to the history of printing processing. To which set labels specified in S51 in FIG. 7 belong can be determined easily from the history of printing and the quantity of the labels that make up the set, and all labels belonging to that set can be regarded as objects for printing.

Next, ordinary printing processing that is executed in the main routine will be described with reference to FIG. 9. When ordinary printing processing is started, printing is performed on label paper 81 according to a known method based on specified print data (S111). Then, the ordinary printing cutoff-setting memory area 341 is now referred to and a determination is made as to whether or not cutoff setting has been made for purposes of cutting each label at the time of ordinary printing (S113). If the cutoff-setting is ON (S113: YES), cutting processing is executed for cutting off the label paper 81 together with the mount at the back of a printed label (S115) by the cutter unit 8. If the cutoff-setting is OFF (S113: NO), the processing proceeds to S117 directly.

Next, the history of a label the printing of which has been executed is stored in the history memory area 351 (S117). Printed data may be stored in the history memory area 351 as history, or, alternatively only the history of the execution of printing may be stored in the history memory area 351 with provision also made for reference being made possible to the printed data stored in the printed data memory area 352.

When specified objects for printing are provided in plural sets, a determination is made as to whether or not there is a subsequent object for printing exist (S119). Then, if a subsequent object for printing does exist (S119: YES), the processing returns to S111, and the processing described above is repeated. If, on the other hand, a subsequent object for printing does not exist (S119: NO), the processing returns to the main routine directly.

As described above, the label printer 1 of this embodiment regards labels in sets made up of plural labels as objects for printing. After printed data about a previous printing and history of printing have been stored and the composite counted number of labels in a set has been set previously by change of setting processing, the history memory and the composite counted number of labels in a set can be referred to by executing printing of the labels in a set made up of that composite counted number, and a determination can be easily made as to which set any label among the printed labels belongs. Thus, if a history of printing is performed that is to be executed when it is desired that a printed label need to be reprinted for some reason, labels of the entire set to which that label belongs can be printed. In particular, this can be used preferably in cases where a display screen is small as in this embodiment and detailed information about the history and the labels that make up the set cannot be displayed easily on a list. Further, if the label paper 81 is set so as to be cut in cases of each individual set, each set can be identified easily. Further, because a mark indicating reprinting can be printed in the case of the history of printing, avoidance is possible of an inconvenience in which new printing gets mixed with labels which have already been reprinted.

As described above, the label-printing apparatus stores the history of printing the labels and the quantity of labels constituting the set of the labels and when an instruction for printing a history is input by a user, extracts the print data of the set of labels to which the label specified by the history of printing instructions belongs and prints it. Consequently, by specifying only a single label, the entire set of the labels which that label belongs to can be reprinted. As a result, specification on reprinting when labels intended to be used always in pair are to be printed does not become complicated, which is convenience for use.

Because in the label-printing apparatus, storing of the history is carried out in the order of printing and additionally, the quantity of the labels that make up the set thereof is stored, to which set a specified label belongs can be determined easily from the memory of the history and the quantity of the labels.

Further, the label-printing apparatus can select whether when the instructions for the history of printing is input, only a specified label is to be printed or the entire set of the labels to which that specified label belongs is to be printed. Consequently, if only the specified label is desired to be reprinted for some reason, printing of the entire set thereof can be avoided.

Because in the label-printing apparatus, after the set of the labels is printed, the labels are cut by each set, each set of the labels can be distinguished easily and therefore, the printed labels can be handled easily.

Further, in the label-printing apparatus, cutting of each label by unit can be selected if the set of the labels is desired to be cut by the unit of each label. Consequently, this label-printing apparatus can be used appropriately depending on each user's application.

In the label-printing apparatus, when the history is printed, the mark indicating the reprint is printed on a label or a mount of the label. Consequently, an error of using both a reprinted label and an original printed label at the same time can be prevented.

In the illustrated embodiment, the controller (CPU11) preferably is implemented using a suitably programmed general purpose computer, e.g., a microprocessor, microcontroller or other processor device (CPU or MPU). It will be appreciated by those skilled in the art, that the controller also can be implemented as a single special purpose integrated circuit (e.g., ASIC) having a main or central processor section for overall, system-level control, and separate sections dedicated to performing various different specific computations, functions and other processes under control of the central processor section. The controller also can be implemented using a plurality of separate dedicated or programmable integrated or other electronic circuits or devices (e.g., hardwired electronic or logic circuits such as discrete element circuits, or programmable logic devices such as PLDs, PLAs, PALs or the like). The controller also can be implemented using a suitably programmed general purpose computer in conjunction with one or more peripheral (e.g., integrated circuit) data and signal processing devices. In general, any device or assembly of devices on which a finite state machine capable of implementing the described procedures can be used as the controller.

While the invention has been described with reference to exemplary embodiments, it is to be understood that the invention is not limited to the exemplary embodiments or constructions. While the various elements of the exemplary embodiments are shown in various combinations and configurations, which are exemplary, other combinations and configurations, including more, less or only a single element, are also within the spirit and scope of the invention.

What is claimed is:

1. A label-printing apparatus comprising:
a printing device that prints a set of labels that constitute related sequential labels;
a history memory device that stores a history of the printing of the labels;
a printed data memory device that stores print data of printed labels whose history is stored in the history memory device;
a counted number memory device that stores the quantity of labels that make up a set of the labels;
a history of printing instructions input device that inputs a history of printing instructions for reprinting by specifying a label stored in the history memory device;
a label-extracting device that extracts a set of labels to which belongs a specified label specified by the history of printing instructions input by the history of printing instructions input device by referring to a counted number stored in the counted number memory device and a history stored in the history memory device; and
a set of labels printing control device that control so as to read the print data of the set of labels, the print data extracted by the label-extracting device from the print data memory device and to print the print data by the printing device.

2. The label-printing apparatus according to claim 1 wherein the label-extracting device includes a set of
labels-determining device that gathers together labels, whose history has been stored in the order of printing by the history memory device in sets of each quantity stored in the counted number memory device, and determines each set of labels that has been gathered together as a set of labels; and the label-extracting device extracts the set of labels to which the specified label belongs from among the sets of labels determined by the set of labels-determining device.

3. The label-printing apparatus according to claim 1 further comprising
an object for printing selection device that if a history of printing instruction is input by the history of printing instructions input device, selects printing of only the specified label or printing of the entirety of the set of labels to which the specified label belongs, wherein
the label-extracting device, if printing of only the specified label is selected by the object for printing selection device, extracts only the specified label and, if printing of the entirety of the set of labels to which the specified label belongs is selected, extracts the set of labels to which the specified label belongs.

4. The label-printing apparatus according to claim 1 further comprising:
a cutting device that cuts a label printed by the printing device and
a cutting control device that cuts out the labels that make up a set in units of sets of labels by means of the cutting device when the set of labels is printed.

5. The label-printing apparatus according to claim 4 further comprising:
an object for cutting selection device that selects whether or not to cut each of the labels that make up the set of labels printed by the printing device, wherein
the cutting control device cuts each label by means of the cutting device when printing of each label is selected by the object for cutting selection device.

6. The label-printing apparatus according to claim 1 further comprising:
a reprint mark-printing control device that controls the printing device so as to print a mark indicating a reprint when a history of printing instructions is input by the history of printing instructions input device.

7. A label-printing apparatus comprising:
a printing device that prints a set of labels that constitute related sequential labels;
a history memory device that stores a history of the printing of the labels;
a printed data memory device that stores print data of printed labels whose history is stored in the history memory device;
a counted number memory device that stores the quantity of labels that make up a set of the labels;
a history of printing instructions input device that inputs a history of printing instructions for reprinting by specifying a label stored in the history memory device; and
a control device that controls so as to extract a set of labels to which belongs a specified label specified by the history of printing instructions input by the history of printing instructions input device by referring to a counted number stored in the counted number memory device and a history stored in the history memory device and to read the print data of the extracted set of labels from the printed data memory device and to print the print data by the printing device.

8. The label-printing apparatus according to claim 7 wherein the control device gathers together labels, whose history has been stored in the order of printing by the history memory device in sets of each quantity stored in the counted number memory device, determines each set of labels that has been gathered together as a set of labels and extracts the set of labels to which the specified label belongs from among the determined sets of labels.

9. The label-printing apparatus according to claim 7 wherein,
the control device that if a history of printing instructions is input by the history of printing instructions input device, selects printing of only the specified label or printing of the entirety of the set of labels to which the specified label belongs, and if printing of only the specified labels is selected, extracts only the specified label and, if printing of the entirety of the set of labels to which the specified label belongs is selected, extracts the set of labels to which the specified label belongs.

10. The label-printing apparatus according to claim 7 further comprising:
a cutting device that cuts a label printed by the printing device, wherein
the control device cuts out the labels that make up a set in units of sets of labels by means of the cutting device when the set of labels is printed.

11. The label-printing apparatus according to claim 10 wherein the control device selects whether or not to cut each of the labels that make up the set of labels printed by the printing device, and cuts each label by means of the cutting device when printing of each label is selected.

12. The label-printing apparatus according to claim 7 wherein,
the control device controls the printing device so as to print a mark indicating a reprint when a history of printing instructions is input by the history of printing instruction input device.

13. A label-printing program recorded in a computer readable recording medium, comprising:
a history-storing step of storing a history of the printing of a set of labels that constitute related sequential labels;
a printed data-storing step of storing print data of printed labels whose history is stored in the history-memory step;
a counted number-storing step of storing the quantity of labels that make up a set of the labels;
a history of printing instructions input step of inputting a history of printing instructions for reprinting by specifying a label stored in the history-storing step;
a label-extracting step of extracting a set of labels to which belongs a specified label specified by the history of printing instructions input in the history of printing instructions input step by referring to a counted number stored in the counted number-storing step and a history stored in the history-storing step; and
a set of labels printing control step of controlling so as to read the print data of the set of labels which is extracted in the label-extracting step and to print the print data.

14. The label-printing program according to claim 13 wherein the label-extracting step includes
a set of labels-determining step of gathering together labels, whose history has been stored in the order of printing in the history-storing step in sets of each quantity that have respectively been stored in the counted number-storing step, and of determining each set of labels that has been gathered together as a set of labels;
and the label-extracting step extracts the set of labels to which the specified label belongs from among the sets of labels determined in the sets of labels-determining step.

15. The label-printing program according to claim 13 further comprising:
an object for printing selection step of selecting printing of only the specified label or printing of the entirety of the set of labels to which the specified label belongs, if a history of printing instructions is input in the history of printing instructions input step wherein
the label-extracting step, if printing of only the specified label is selected in the objects for printing selection step, extracts only the specified label and, if printing of the entirety of the set of labels to which the specified label belongs is selected in the objects for printing selection step, extracts the set of labels to which the specified label belongs.

16. The label-printing program according to claim 13 further comprising:
a cutting control step of cutting a label printed in the set of labels printing control step and,
cutting out the labels that make up a set in units of sets of labels when a set of labels is printed.

17. The label-printing program according to claim 16 further comprising:
an object for cutting selection step of selecting whether or not to cut each of the labels that make up the set of labels printed in the set of labels printing control step, wherein
the cutting control step cuts each label when printing of each label is selected in the objects for cutting selection step.

18. The label-printing program according to claim 13 further comprising:
a reprint mark printing control step of controlling so as to print a mark indicating a reprint in the set of labels printing control step when a history of printing instructions is input in the history of printing instructions input step.
